(19) United States
(12) Patent Application Publication
(10) Pub. No.: US 2008/0320576 A1
(43) Pub. Date: Dec. 25, 2008

(54) Unified online verification service

(75) Inventor: Bruce Curling, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/821,262

(22) Filed: Jun. 22, 2007

(51) Int. Cl. H04L 9/32; G06F 3/01

(52) U.S. Cl. 726/8; 715/741; 726/5

(57) ABSTRACT

A web-based, graphical user interface-driven arrangement for configuring federated access management across a group of federations and associated identity providers is enabled by a centralized server, called a global verification server. The global verification server operates to give service providers who host protected resources (i.e., those that have access restricted to only users having particular attributes, such as being a member of a particular group) a unified view of federations that are typically deployed on a global basis, as well as provides web-based tools to manage federated access. The global verification server also provides a single location on the web where users can go to access protected resources by discovering and using their home identity provider for verified single sign-on.

### BACKGROUND

Online service providers commonly require the verification of personal information in order to provide service to users. Since the protection of the privacy of such personal information is important, and because different service providers typically ask for similar information, the verification process is often both inefficient and redundant. Such inefficiency is evident, for example, in the manual processes that must typically be followed by a user in order to provide proof of their identity. For example, when setting up an account to access an online research library, the library staff might require that the potential user fax in copies of credentials that prove eligibility to use the resources. The staff then typically reviews the credentials manually before setting up an access account having a user name (i.e., login) and password.

This process can be duplicated for other online services furnished by other entities that the user may wish to access. The user may end up with a multiplicity of different user names and passwords in order to access the various online services. Unfortunately, using numerous user names increases the potential for identity theft, and the unauthorized exchange of identities. In addition, the user may become frustrated in trying to manage multiple user names and passwords and may give up when accessing particular online services which can result in negative consequences to both the user and the service provider.

Some organizations, particularly academic institutions like universities and colleges have turned to a collaborative networking system, called federated access management, to deal with identity verification. Single sign-on is established under the federated access paradigm that enables users to access online resources within or across organizational boundaries through verification from an identity provider system that has identity information on record about the user. Federated access management also affords the online content service provider a way to make informed decisions for individual access to protected resources in a manner that preserves user privacy. While such federated identity management performs satisfactorily in many situations, it is typically only deployed on a regional basis which limits is applicability to resources and users located in a wider geographic area or on a global basis. In addition, extending a federation and configuring the rules under which it operates currently requires a substantial amount of customized computer programming to be developed and deployed.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A web-based, graphical user interface (“GUI”)-driven arrangement for configuring federated access management across a group of federations and associated identity providers is enabled by a centralized server, called a global verification server. The global verification server operates to give service providers who host protected resources (i.e., those that have access restricted to only users having particular attributes, such as being a member of a particular group) a unified view of federations that are typically deployed on a global basis, as well as provides web-based tools to manage federated access. The global verification server also provides a single location on the web where users can go to access protected resources by discovering and using their home identity provider for verified single sign-on.

In an illustrative example, the global verification server hosts an identity provider (“IdP”) discovery GUI that amalgamates a multiplicity of federations into a centralized federated access portal. Users can find their familiar home IdP using the GUI, and then sign in for verification for access to the protected resources of service providers that are supported by the global verification server. The discovery and sign on process through the GUI makes single sign-on to all the supported service providers easy for the user, while keeping the organization of the underlying federations transparent.

In another illustrative example, the global verification server hosts a service provider GUI that furnishes a web-based tool to enable service provider administrators with all the functionalities needed to configure the federations that will be trusted by the service provider, along with the user attributes to accept from the trusted federations. Trusted federations and IdPs may be added, modified or deleted, and the acceptance policies by which user attributes are evaluated in making access decisions may be configured using an easy-to-use point-and-click interface.

Advantageously, by unifying the federation concept beyond the current regional deployment, users can access a greater number of protected services through the centralized access portal and service providers can serve more verified users through single sign-on. The global verification server also dramatically streamlines the processes needed to set up and administer the federations that will be trusted by a service provider, and configure attribute acceptance policies because the point and click interface eliminates the need for expensive and time consuming hand-coded programming.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative online networking environment in which online providers furnish services to those users having verified identities;

FIG. 2 shows an illustrative online networking environment that utilizes a centralized verification model;

FIG. 3 shows an illustrative verification methodology that manages access to online services via a federation;

FIG. 4 shows an illustrative verification arrangement that unifies a plurality of federations through a global verification server;

FIG. 5 shows an illustrative architecture for the global verification server shown in FIG. 4;

FIG. 6 shows a first screenshot of an illustrative web-based graphical user interface hosted by the global verification server that facilitates identity provider discovery to a service user;

FIGS. 7 and 8 show, respectively second and third screenshots of the web-based GUI for identity provider discovery;

FIG. 9 shows a first screenshot of an illustrative web-based GUI hosted by the global verification server that enables an administrator at an online service provider to configure the federations it will trust, and the attributes to accept from the trusted federations; and

FIGS. 10-15 show, respectively, second, third, fourth, fifth, sixth, and seventh screenshots of the web-based service provider GUI that is arranged for federation and attribute configuration.

Like reference numerals indicate like elements in the drawings.

### DETAILED DESCRIPTION

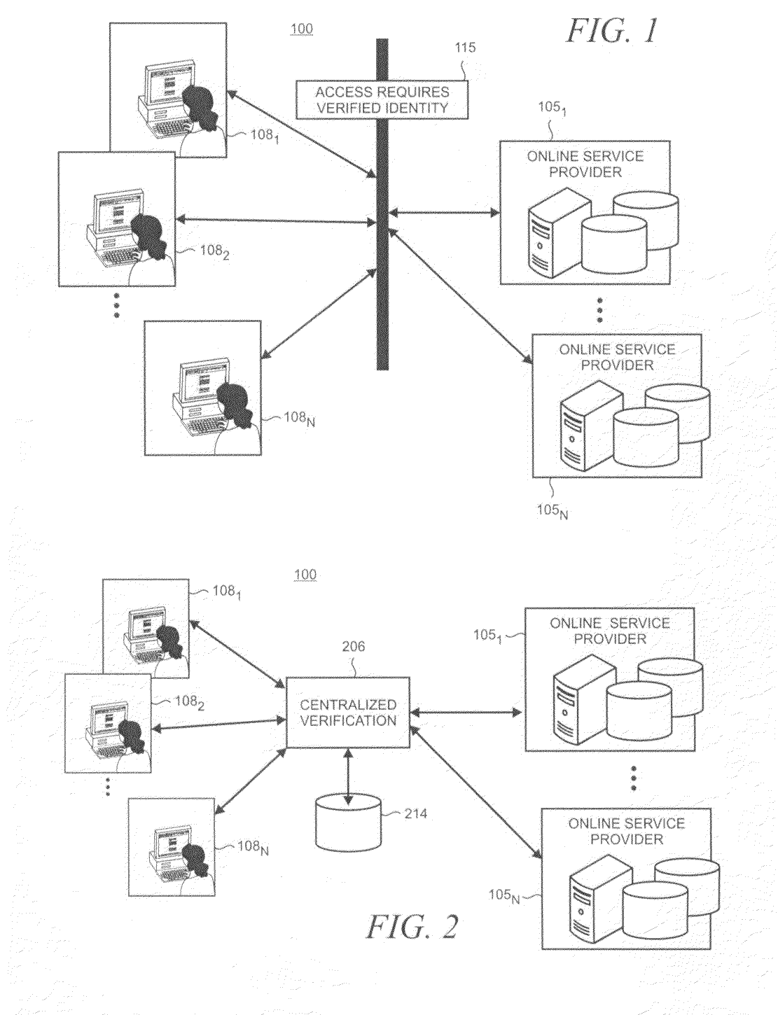

FIG. 1 shows an illustrative online networking environment 100 in which online providers 105-1 . . . N are arranged to provide services, including those implemented through pages on the worldwide web, to various different users 108-1, 2 . . . N, typically over a network that may include public portions such as the Internet. The online service providers 105 can provide a variety of different content or services (hereinafter collectively referred to as “services”) to the users and may include those, for example, relating to commercial enterprises such as e-commerce sites, financial institutions, academic resources such as libraries or course materials, government, healthcare, entertainment, and the like.

In this illustrative example, each of the online service providers 105 provides a service to a protected web-enabled resource. A “protected” resource here is one that requires that the identity of the user 108 seeking access to the online service be verified as meeting certain policy requirements established by the service provider in order to gain access to an online resource, as indicated by reference numeral 115. As used here, the terms “verification” and “verify” are used to include both an authentication process by which a user is identified, and an authorization process by which the authenticated user is granted access to the resource.

Identity verification typically entails some corroboration of a set of attributes relating to a particular user and which are of particular interest to the online service provider. Attributes are the characteristics or features that are associated with an individual user and include, for example, age, gender, demographic profile (occupation, residence, income level, etc.) or any other such descriptive information. Attributes can also be associated with particular settings. For example, in an academic setting, attributes may include those describing a user's position (e.g., student, staff member, or faculty), or the department in which the user studies or works. A service provider will make a decision as to whether to grant or deny access to a service based on such attributes. The service could be, for example, one that utilizes a protected resource like a database containing student academic records. Thus, if a user 108 has the desired attributes—for example, the user is an administrator at a specific college—then the service provider will grant access to the service.

It is emphasized that while this description uses examples that are primarily from an academic environment, the present arrangement for unified online verification is not limited to only applications in that environment. The present verification may also be extended to other audiences of users beyond university students, staff, and faculty, and include virtually any online service provider that wants or needs to grant access to users having attributes which meet certain criteria. For example, and not by way of limitation, a retailer might wish to engage in a targeted marketing campaign to provide discounted pricing that is available only to college students. A link to the retailer's e-commerce website can be advertised on television, provided via e-mail or direct mail, etc. so that the targeted students can access the site and place orders under the special pricing scheme. However, the retailer is only willing to provide the discounted pricing to users hitting the site that have the desired attributes of being college students whose identities are verified.

FIG. 2 shows the online networking environment 100 that utilizes a centralized verification model by which verification of users 108 may be performed. In this illustrative example, a central resource 206 provides an identity proofing service on behalf of one or more of the online service providers 105. Processes utilized by the central resource 206 are generally manual. These include manual verification of data provided by the users 108, which commonly requires the user to fax in copies of credentials (e.g., student ID, faculty pay stubs, etc.) to prove they are who they claim to be. Human operators also typically are required to enter a user into a database 214. Once this is completed, the user is verified from the database 214 in an automated manner (in a process called self-identification) for every access to a service provider 105. Centralized verification generally works well once implemented, but the manual identity proofing processes used can be time consuming and expensive. In addition, centralized verification typically does not scale well.

Organizations are increasingly relying on federated access management to deal with verification which uses a trust relationship model. Federated access management is also known as federated identity management.

In the trust relationship model, if Organization A trusts Organization B, then Organization A will accept a user if that user is verified by Organization B. Shibboleth® is the name of a standards-based, open source middleware that is commonly one of the tools used to implement federated access with the trust relationship model. Shibboleth is an initiative of the Internet2 networking consortium.

Federated access under Shibboleth makes use of the fact that many organizations such as schools and employers commonly deploy identity provider (“IdP”) systems to issue user identities and logon credentials for a set of users. These issued identities are used to control access to protected online resources like payroll records, school databases, online journals, web-enabled resources, and the like. A user goes to the IdP at his or her home organization and uses a logon and password to thereby gain access to the requested resource.

Identity providers function as the authoritative source for verifying their users and can therefore “vouch” for the user identity and their entitlements in a federated interaction with service providers. Shibboleth leverages such verification authority of the home organization's IdP to enable cross-domain single sign-on by exchanging data across domain boundaries using shared protocols and methodologies. The Security Assertion Markup Language (“SAML”) protocols are one of the most widely adopted mechanisms to exchange the authentication and authorization data for federated access management.

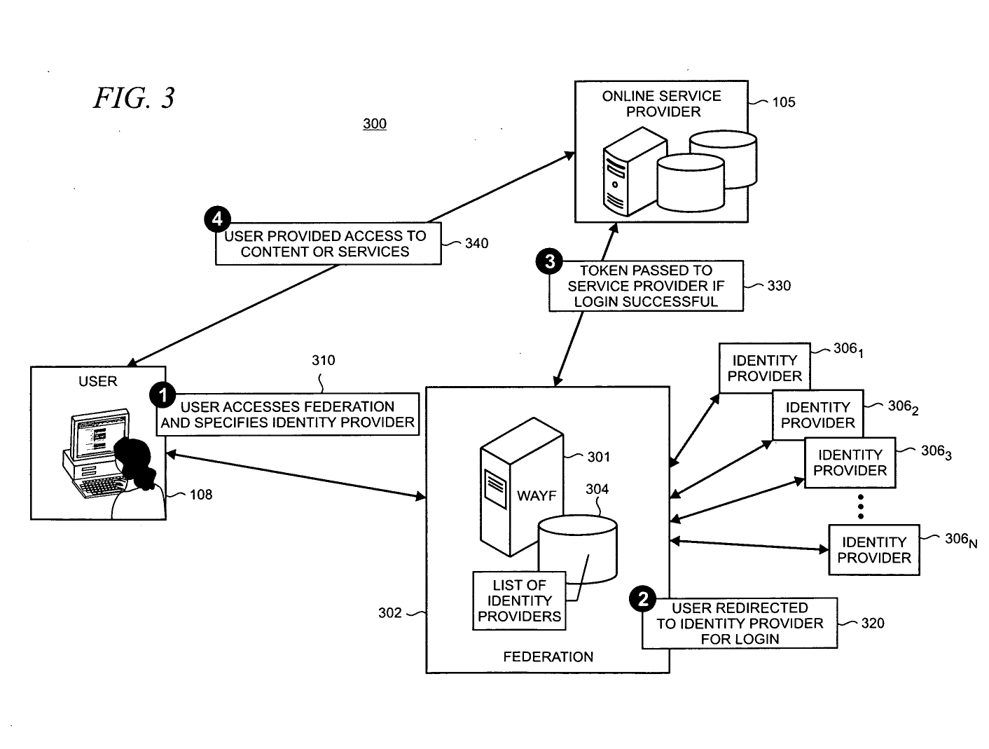

FIG. 3 shows a typical Shibboleth verification methodology applicable to a federated access management system 300 which includes a central, trusted service known as “WAYF” 301 (where are you from) that is provided by a federation 302. The federation 302 enables a user 108 to identify the user's home institution from a list 304 that points to a multiplicity of IdPs 306-1, 2 . . . N. In this example, IdPs 306 represent different organizations that have joined the federation 302 and who have agreed to operate, along with service providers, under common rules to implement a trust relationship. Thus, federated access management involves cooperation among multiple entities including a federation which operates a WAYF, the services providers, and the IdPs. The trust relationship among these various entities is manifested using shared metadata which contains the definition and description of each entity participating in the federated access. Metadata includes, for example, URLs (Uniform Resource Locators), and the public key certificates needed to judge the validity of messages that are exchanged among the entities.

As noted above, while IdPs 306 may be operated by schools, other organizations may operate an IdP 306 through which a user associated with such organization is verified. IdPs 306 further convey the user's attributes to an online service provider 105 which makes access decisions based on those attributes.

Federation 302 is representative of the existing federations that each manages a WAYF server 301. Currently, most federations are organized on a national basis, although some countries have more than one federation operating.

The verification methodology in FIG. 3 starts with step 1, indicated by reference numeral 310, where a user 108 is directed to the federation 302. For example, the user 108 could be pointed to the federation 302 by being redirected after attempting to request a resource on the service provider 105, but not being recognized by the service provider.

The WAYF 301 presents the list 304 of IdPs 306 to the user 108 from which the user is asked to select the user's home IpD (e.g., his or her institution such as school or other organization). The user 108 then selects the appropriate IpD from the list 304.

At step 2, indicated by reference numeral 320, the user is redirected to the selected IpD 306 to be verified through the user's normal login process. If the login is successful, at step 3 (reference numeral 330), a token is passed to the service provider 105 to indicate that the user 108 is verified. The token is a symbol of user verification and trust among the entities that participate in the federated access.

The service provider 105 will pass the token to the user's IdP 306 asking for attributes of the user. The IdP will typically pull the user attributes from a database (not shown) and send the attributes to the service provider 105. The service provider will check the received attributes against its attribute acceptance policies and will grant or deny access accordingly. Assuming that the user's attributes meet the policy, the user 108 is then provided with access to the requested content, as shown at step 4 (reference number 340). Use of the token and attributes enables the trust relationship to be invoked, while ensuring that the user's identity is protected and no personally identifiable information (“PII”) is actually exchanged.

Federated access management can provide some advantages over the centralized verification model described above in the text accompanying FIG. 2. For example, the single sign-on is generally valued by users, and fewer resources are expended in issuing and managing multiple user accounts and passwords across domains and with multiple service providers. And since the user's logon/account is managed by the user's home institution's IdP, it can be properly protected and removed when a user no longer has the right to access resources which provides confidence that personal data is secure and not subject to abuse.

However, federated access management is not currently available beyond a particular region where a federation is located. Therefore, service providers do not currently have a way to reach potential users across federations. And the concepts of single sign-on through use of the trust model, and access decisions being made based on user attributes are unable to be implemented on a more global basis.

Service providers may also face difficulties when establishing and administering the attribute acceptance policies that are integral to the federated access model. Typically, a significant amount of customized software code must be developed for a service provider to establish which federations and IdPs to trust, and also to set up the attribute acceptance policies that decide which users from those trusted federations are granted access to a particular resource. For example, it is not unusual for specialized developers to have to work for several months to hand code a set of attribute acceptance policies to enable a service provider to take advantage of federated access.

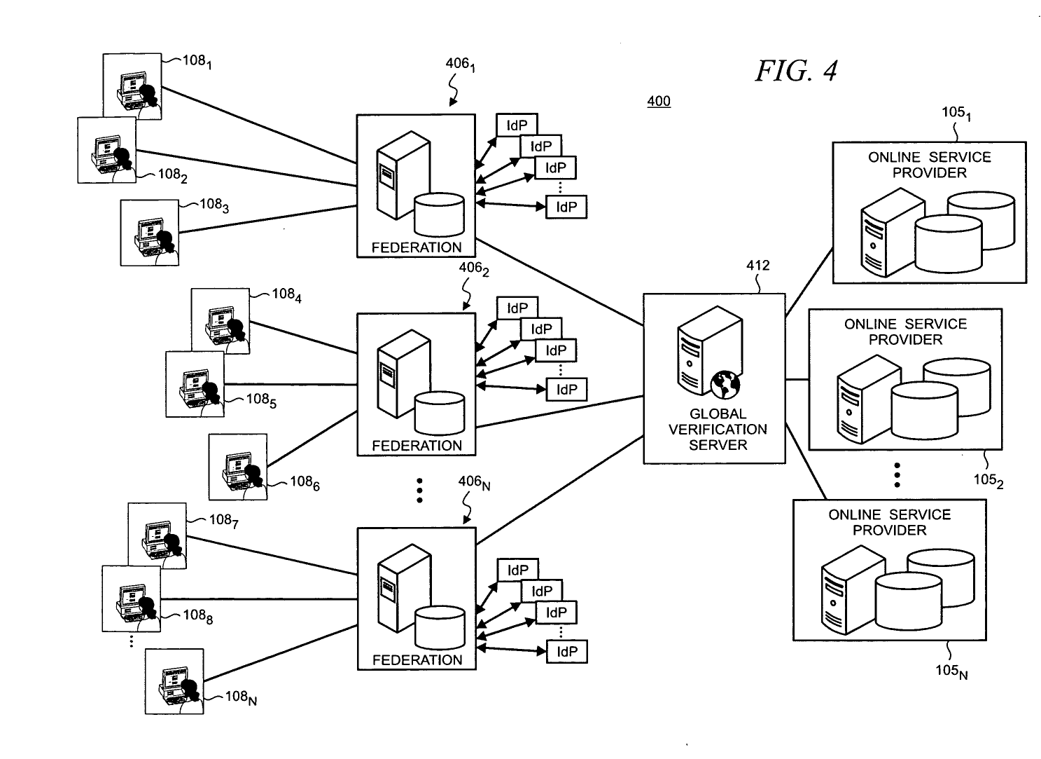

FIG. 4 shows an illustrative verification arrangement 400 that unifies a multiplicity of federations and their associated IdPs as indicated by reference numerals 406-1, 2 . . . N through a global verification server 412. Verification arrangement 400 operates by amalgamating the current regionally-deployed federations using the global verification server 412 as a focal point for both users and service providers.

The global verification server 412 is arranged to provide IdP discovery to groups of users 108-1, 2 . . . N that are associated with respective federations 406, as shown. This feature enables a user, irrespective of their location, or the federation to which their IdP is associated, to come to one location to access the variety of services provided by the service providers 105 using a single log-in provided by the familiar IdP of their home institution.

In addition, the global verification server 412 is arranged to provide a unified view to service providers 105 of the multiplicity of federations 406. This feature enables a service provider 105 to implement federated access across the multiple federations 406 supported by the global verification server 412 through a single interface. Both features are described in detail below.

The global verification server 412 is arranged, in this illustrative example, to operate in conjunction with a Microsoft IIS (Internet Information Server) web server (not shown) to facilitate utilization of a centralized architecture. However, it is emphasized that distributed architectures may also be used in some settings by implementing the services and functionalities provided by the global verification server at each of the service providers 105.

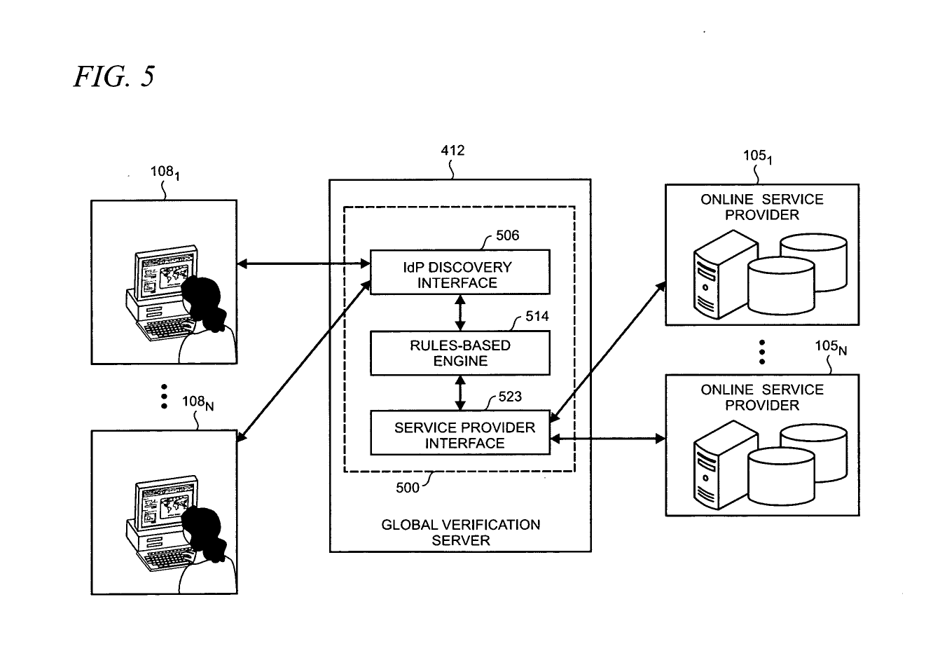

FIG. 5 shows an illustrative architecture 500 for the global verification server 412. Architecture 500 includes several functional components including an IdP discovery interface 506, a rules-based engine 514, and a service provider interface 523. The service provider interface 506 and IdP discovery interface 523 are each operatively coupled to the rules-based engine 514, as shown, and enable respective interaction with users 108 and service providers 105.

The IdP discovery interface 506 is arranged to provide a web-based graphical user interface (“GUI”) to users. The GUI provides users with an easy way to locate and use their regular IdP whenever they are seeking access to resources provided by service providers 105 that are supported by the global verification server 412.

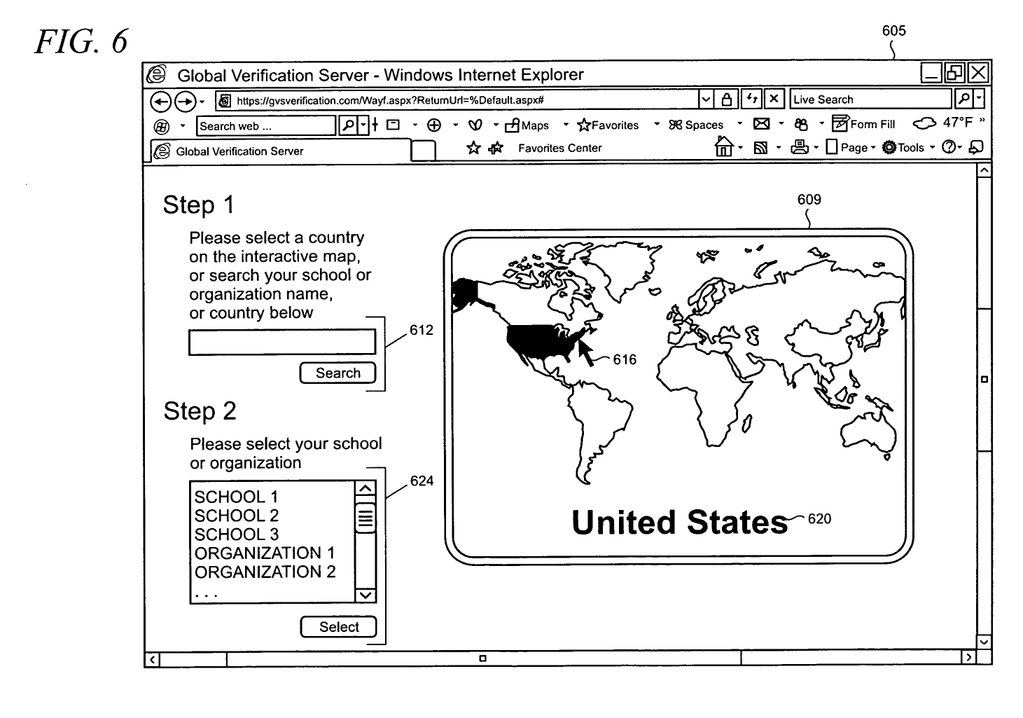

FIG. 6 shows a first screenshot 605 of an illustrative web-based GUI that is provided by the IdP discovery interface 506 (FIG. 5) to users when they first seek access to a service provider 105 supported by the global verification server. Screenshot 605 includes an interactive global map 609 that amalgamates all of the different federations that are available worldwide. The IdP discovery GUI directs the user to first select the country in which they are located by either clicking on their country on the map 609, or by completing a search field 612 to identify their school or organization. Here, the user has positioned the mouse cursor 616 over the United States which becomes highlighted. A corresponding caption 620 is also displayed.

Once the country is selected, an interactive menu of IdPs that are associated with the federation(s) in the selected country is displayed in a menu 624. In this illustrative example, menu 624 shows several IdPs operated by different schools and organizations. The user selects the user's home school or organization from menu 624. The global verification server 412 will redirect the user to the user's IdP so that the user can then log in and be verified by their IdP following their usual process. While a the use of the interactive global map 609 provides an easy-to-use graphical representation of countries, it is emphasized that other GUI objects, both graphical and text-based may also be used in some applications of the present arrangement. For example, a drop down or other menu which lists counties by name may be utilized.

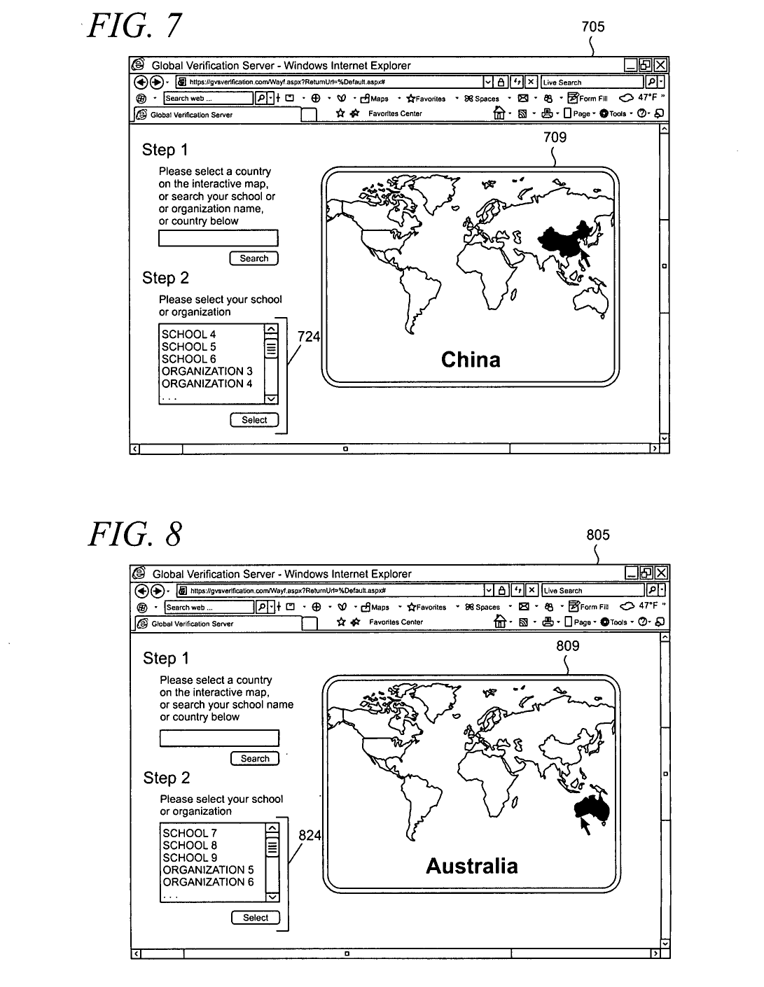

FIG. 7 shows a second illustrative screenshot 705 of the GUI provided by the IdP discovery interface 506 (FIG. 5). In this example, the user has selected China from the interactive global map 709 as the country in which the user is located. In accordance with the present arrangement for unified online verification, the GUI responsively shows an interactive menu 724 of IdPs that belong to the federation(s) in China. The IdPs are associated with schools and organizations that are different from those shown in the example shown in FIG. 6. Similarly, FIG. 8 shows a third illustrative screenshot 805 of the GUI provided by the IdP discovery interface 506 (FIG. 5) in which the user has selected Australia from the interactive global map 809. A third set of IdPs associated with the federation(s) in Australia is displayed in an interactive menu 824.

The IdP discovery GUI shows different menu choices in a similar manner as described above for the other countries from which a user may select using the interactive global map. In each case, the global verification server 412 redirects the user to the IdP chosen from the menu for log in and verification. The IdP discovery GUI thus facilitates user access to all of the service providers supported by the global verification server 412 using single sign-on through the IdP of their home institution in a manner in which the underlying federation infrastructure is kept transparent to the user.

The service provider interface 523 in the architecture 500 supported by the global verification server 412 (FIG. 5) is arranged to provide a web-based GUI that enables an administrator at an online service provider to configure the federations it will trust, and the attributes to accept from the trusted federations. The GUI provides an easy-to-use point and click interface that implements all the functionality needed to set up and administer federated access to the service provider's site without the need for customized programming.

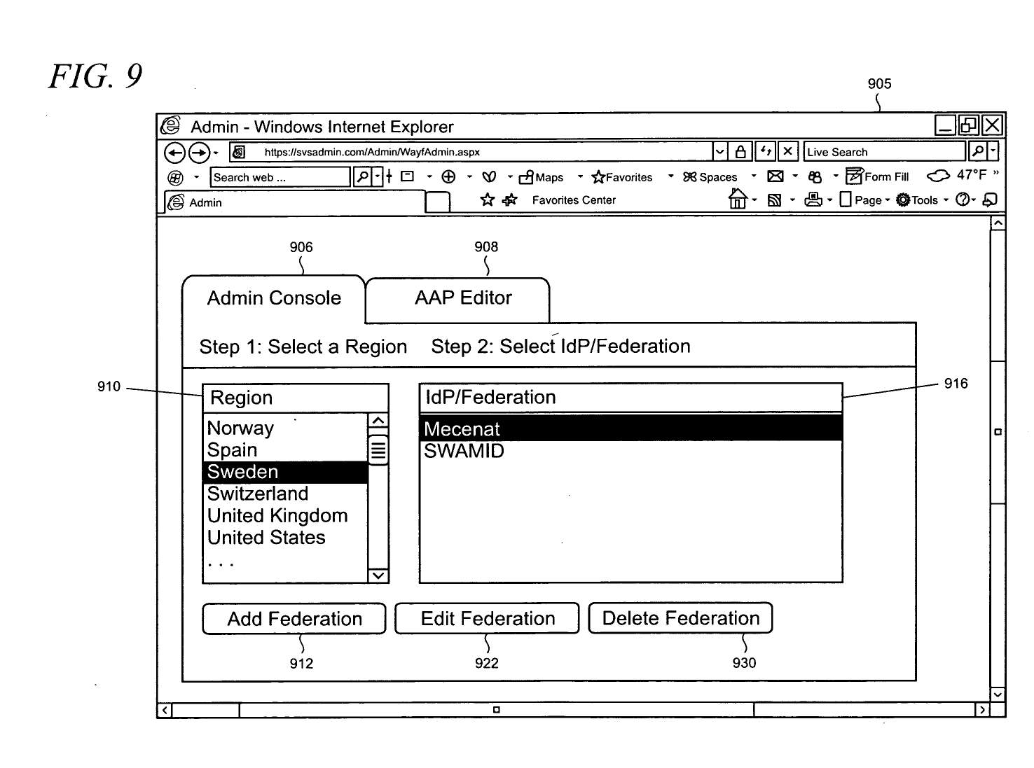

FIG. 9 shows a first screenshot 905 of an illustrative web-based GUI that is supported by the service provider interface 523 (FIG. 5). The service provider GUI is organized with two functional components—an administrator or “Admin” console, and an attribute acceptance police (“AAP”) editor. Screenshot 905 shows the interactive menus and controls displayed through the Admin console which are arranged to enable a service provider administrator to add federations that the service provider will trust (i.e., grant access to protected resources to users associated with that federation under a trust relationship model described above), as well as edit and delete federations. In this example, these two components are accessed through respective tabs 906 and 908 in the service provider GUI.

Screenshot 905 shows that a number of regions and associated IdP/Federations are currently configured as being trusted by the service provider who is accessing the service provider interface 523. In this example, Sweden is shown as being selected by the administrator in the “Region” menu 910. By clicking the “Add Federation” button 912, the administrator is provided with a screen (i.e., webpage) by which additional federations in Sweden may be added as federations that are trusted by the service provider.

The GUI also indicates, in a window 916, that two IdP/Federations (“Mecenat and “SWAMID”) are associated with this region and which are part of the service provider's trust circle. The administrator may select an IdP/federation to edit or delete, as is shown by the selection of the “Mecenat” federation in this example. By clicking on the “Edit Federation” button 922, the administrator is provided with a screen by which information associated with the selected IdP/Federation may be updated or modified. Clicking on the “Delete Federation” button 930 deletes the selected IdP/Federation from the service provider's trust circle.

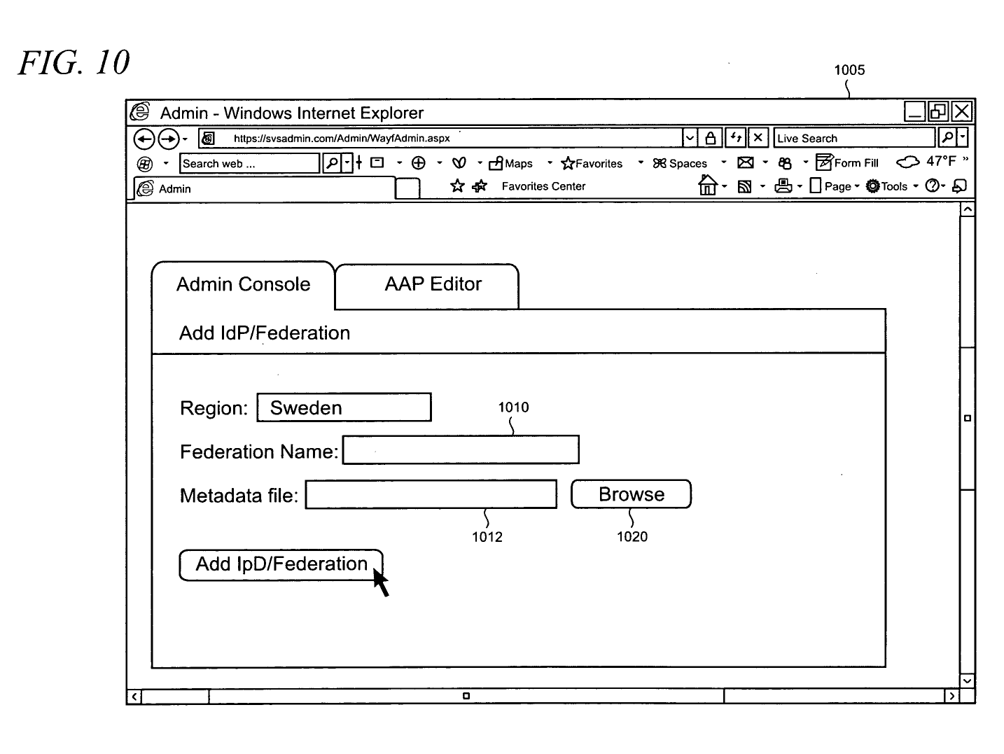

FIG. 10 shows a second illustrative screenshot 1005 of the service provider GUI that is supported by the service provider interface 523. Screenshot 1005 represents the screen that the service provider GUI provides in response to use of the “Add Federation” button 912 shown in the previous screenshot (FIG. 9). The service provider GUI is arranged here to enable an administrator to specify the name of the federation to be added in the name field 1010. The file name and path of a metadata file may be specified by the administrator in the text box 1012. Or, the administrator may search for the metadata file using the “browse” button 1020. As noted above, metadata includes descriptive information about entities that participate in federated access. In this example, metadata supplied by the service provider typically identifies the URLs for which the service provider is maintaining protected resources that may be accessed via the federation.

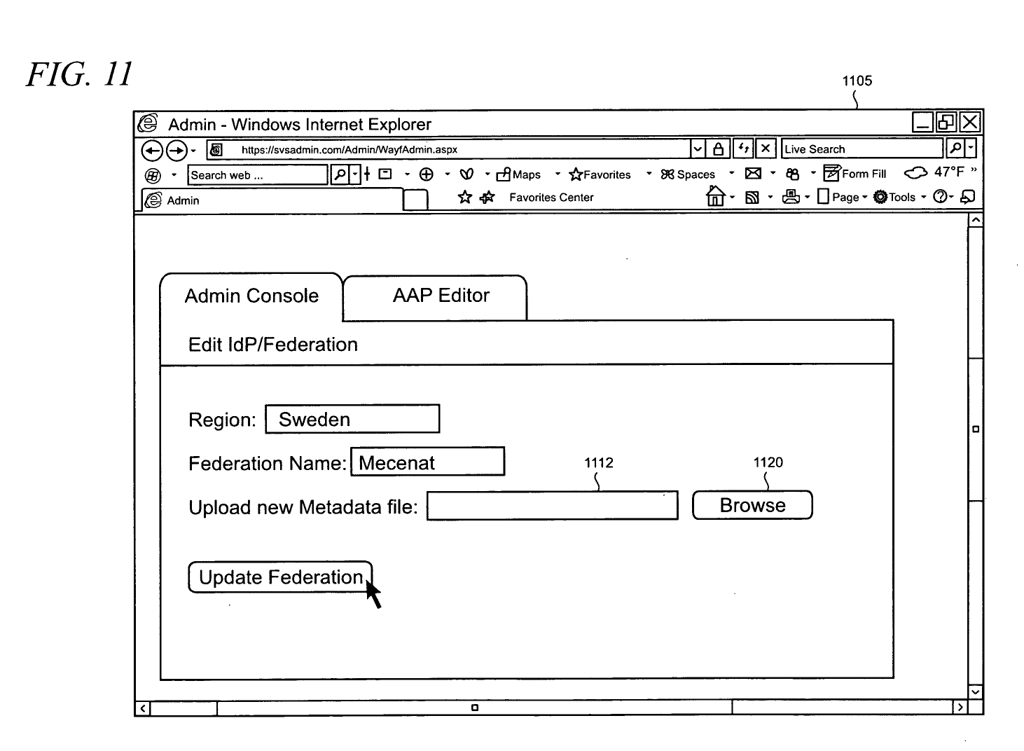

FIG. 11 shows a third illustrative screenshot 1105 of the service provider GUI that is supported by the service provider interface 523 (FIG. 5). Screenshot 1105 represents the screen that the service provider GUI provides in response to the “Edit Federation” button 922 shown in FIG. 9. The service provider GUI is arranged here to enable an administrator to upload a new metadata file to the selected IdP/federation (i.e., Mecenat). The service provider administrator may type a file name and path for a new metadata file into the text entry window 1112, or search for it using the “browse” button 1120. The new metadata file may then be uploaded to the global verification server 412 (FIG. 4).

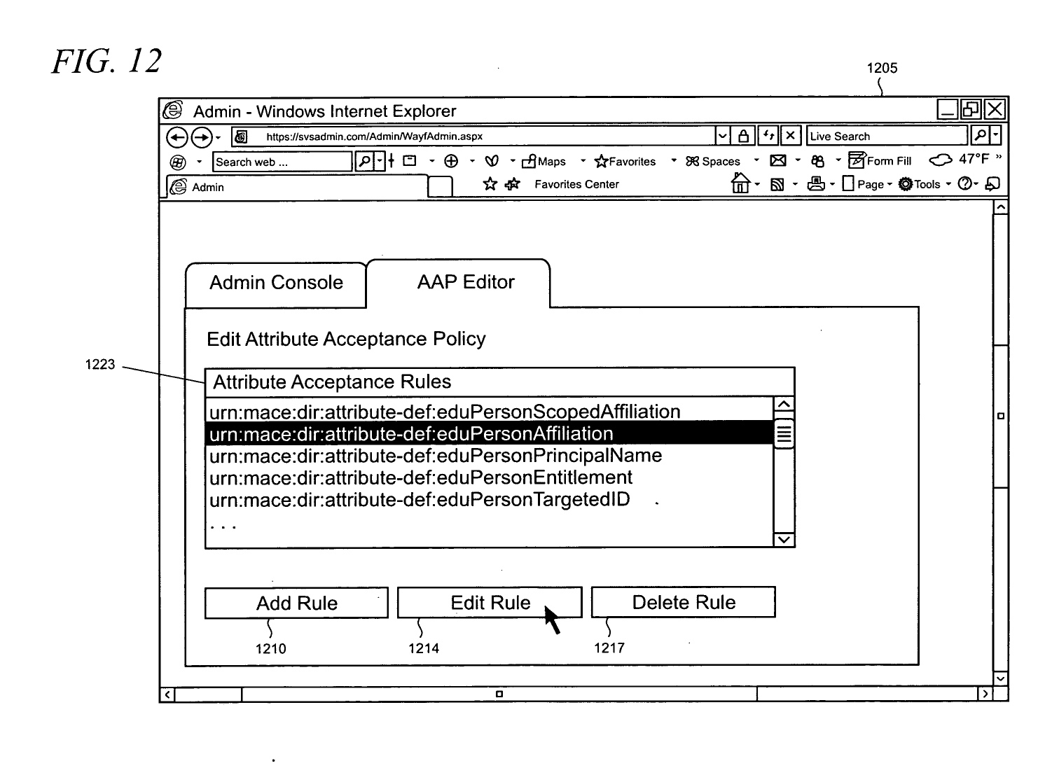

FIG. 12 shows a fourth illustrative screenshot 1205 of the service provider GUI that is supported by the service provider interface 523 (FIG. 5). Screenshot 1205 shows the interactive menus and controls displayed through the AAP editor which are arranged to enable a service provider administrator to set up and administer the attribute acceptance policies. Attribute acceptance policies are rules which govern the attributes the service provide will accept from a user in order to grant access to a protected resource. Working through the AAP editor in the service provider GUI, an administrator may add rules, edit rules, and delete rules through the respective buttons 1210, 1214, and 1217.

Screenshot 1205 displays a number of illustrative attribute acceptance rules in a rules window 1223 which are expressed using conventional attribute definition syntax from the Internet2 MACE-Dir working group under the SAML specifications (where MACE stands for Middleware Architecture Committee for Education). In this example, a rule “eduPersonAffiliation” is shown as being selected by the administrator. By clicking the “Edit Rule” button 1214, the administrator is provided with a screen by which the rule may be edited.

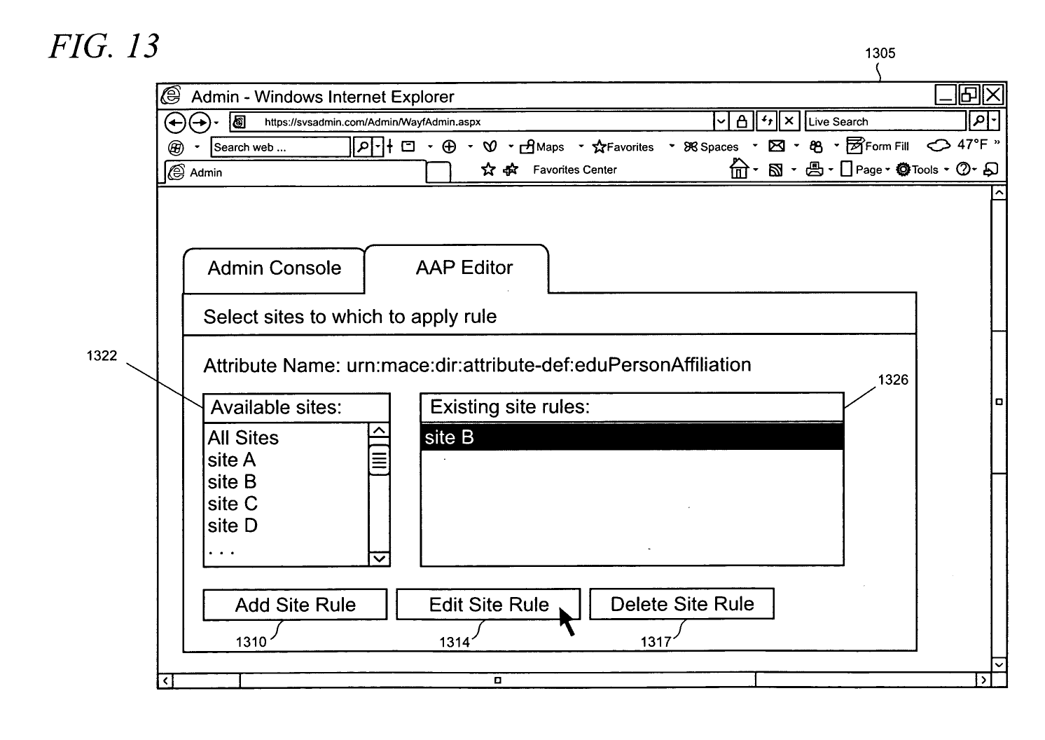

FIG. 13 shows a fifth illustrative screenshot 1305 of the service provider GUI and represents the screen provided in response to use of the “Edit Rule” button 1214 shown in the previous screen shot (FIG. 12). The service provider GUI is arranged here to enable an administrator to apply the rule selected at the previous screen (in this case, the eduPersonAffiliation rule) to selected sites, edit the rule, or delete the rule through use of respective buttons 1310, 1314, and 1317. Screenshot 1305 shows the sites (i.e., IdPs) that are available to which the rule may be applied in window 1322, as well as a listing of sites to which the rule is currently applied in window 1326. Some rules may be applied to all sites, or alternatively to a subset of sites. As shown in screenshot 1305, the current rule is currently applied to site B.

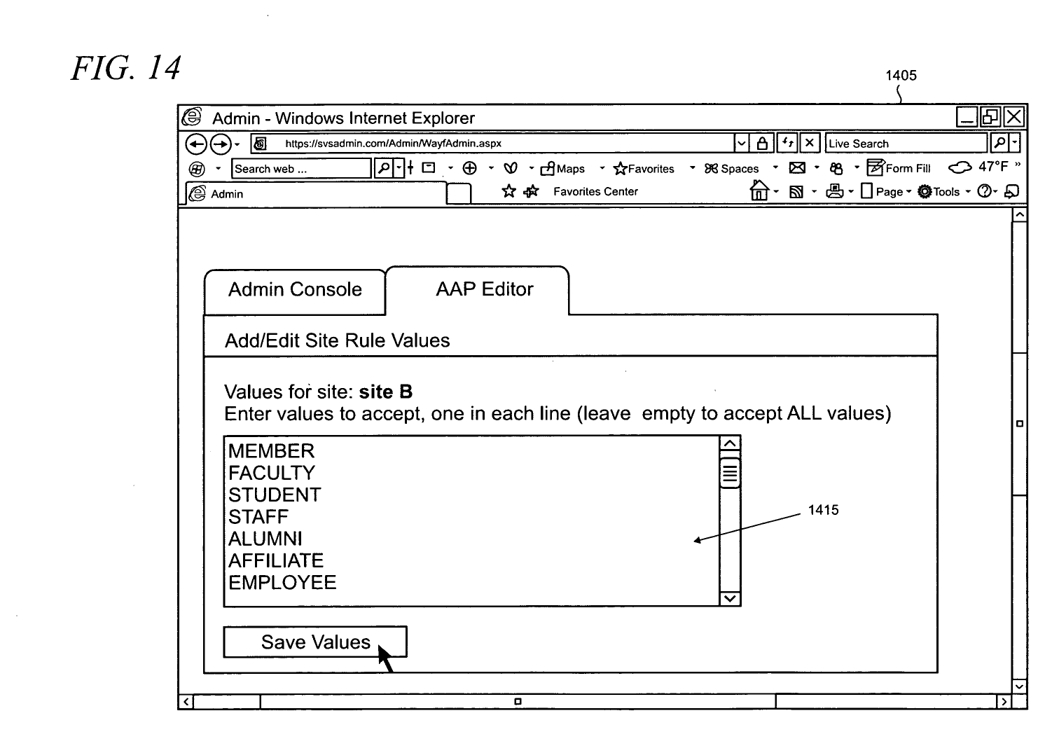

In this example, the administrator has selected to edit the eduPersonAffiliation rule as currently applied to site B. The administrator is presented with the screen shown in FIG. 14 which shows a sixth illustrative screenshot 1405 of the service provider GUI by which attribute values for a selected site (in this case site B) may be input into a field 1415. Field 1415 is arranged to accept multiple lines of input for attribute values. Here, several illustrative values are shown including, member, faculty, student, etc. The administrator may also accept all values for a given attribute by leaving field 1415 blank as indicated in the screenshot 1405.

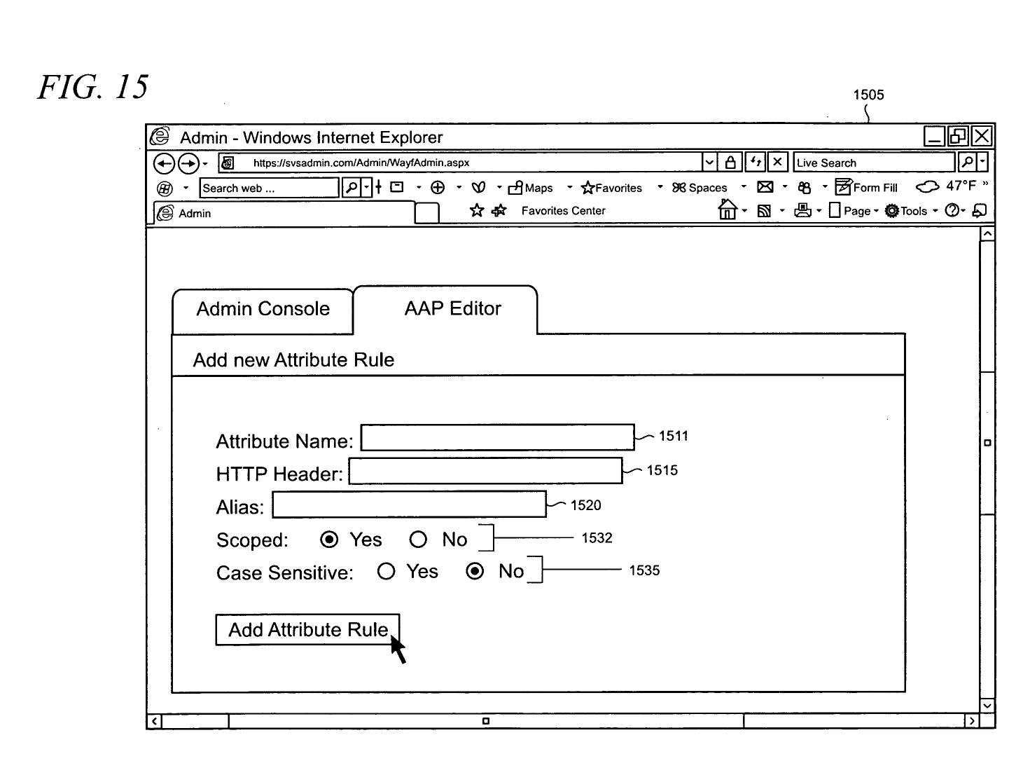

FIG. 15 shows a seventh illustrative screenshot 1505 of the service provider GUI and represents the screen provided in response to use of the “Add Rule” button 1210 shown in the screen shot 1205 (FIG. 12). The service provider GUI supported by the service provider interface 523 (FIG. 5) is arranged here to enable an administrator to add a new attribute rule that is used in the decision by the service provider as to whether to grant access to a user to a protected resource.

The service provider GUI provides respective fields 1511, 1515, and 1520 for the administrator to specify the attribute name, an HTTP (HyperText Transfer Protocol) header, and an alias for the attribute. In this example, the attribute is typically assigned a name in the form of a URI (Uniform Resource Identifier) in accordance with the Internet2 MACE-Dir Working Group. The HTTP headers provide header names to which user attributes are mapped when published to the service provider by an IdP. Such mapping typically enables application of the service provider's authorization rules using a localized vocabulary. The alias is a short name for the attribute and is typically used as a reference.

Radio buttons 1532 and 1535 are provided, respectively, to enable the administrator to specify whether the new attribute rule is scoped or case-sensitive. A scoped attribute, as used in Shibboleth, is a special kind of attribute defined by both attribute values and scope (i.e., context). An attribute may be scoped to a particular IdP so that, for example, attributes from the IdP will only be trusted by the service provider when scoped to that IdP.

The service provider GUI provides other menu choices in a similar manner as described above for an administrator to add new acceptance rules, edit existing rules, select IdPs to which the rules are applied and so forth. The service provider GUI supported by the present global verification server thus enables an administrator to conveniently add new federations and IdPs to its trust circle and configure the acceptance rules that govern which attributes to accept from those trusted entities when making user access decisions. As such capabilities are enabled using a web-based point and click interface, no specialized coding is required which can typically result in considerable savings for the service provider. Moreover, the federations and IdPs may be added and configured quickly which introduces a new federation access paradigm in which federated access may be managed on a flexible and ad-hoc basis.

Returning again to FIG. 5, the interfaces supporting the IdP discovery and service providers GUIs described above in the text accompanying FIGS. 6-15 are each coupled to a rules-based engine 514 in architecture 500 of the global verification server 412. The rules-based engine 514 is arranged to accept data collected through the GUIs supported by the respective interfaces to enable single sign-on from users across all federations supported by the global verification server by redirecting a user to the IdP at the user's home institution. In addition, the rules-based engine 514 enforces the attribute acceptance policies defined by a service provider using the point and click GUI so that only users having the specified attributes will be given access to protected resources hosted by the service provider.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable storage medium containing instructions which, when executed by one or more processors disposed in an electronic device, performs a method for configuring federated access to a resource operated by a service provider, the method comprising the steps of
providing a plurality of entities on a GUI, each entity in the plurality participating in federated identity management;
accepting input to the GUI for specifying an entity from the plurality for inclusion in a trust relationship with the service provider; and
providing controls on the GUI for configuring attribute acceptance rules that are applicable to user attributes associated with the specified entity.

2. The computer-readable storage medium of claim 1 in which the entities are selected from ones of federations or identity providers.

3. The computer-readable storage medium of claim 1 in which the controls comprise one or more point and click objects arranged for adding a new attribute acceptance rule.

4. The computer-readable storage medium of claim 1 in which the controls comprise one or more point and click objects arranged for editing an attribute acceptance rule.

5. The computer-readable storage medium of claim 1 in which the controls comprise one or more point and click objects arranged for deleting an attribute acceptance rule.

6. The computer-readable storage medium of claim 1 in which attribute acceptance rules are usable by the service provider for determining access to the resource based on the user attributes.

7. The computer-readable storage medium of claim 6 in which the user attributes are defined in accordance with Internet2 MACE.

8. The computer-readable storage medium of claim 1 in which the resource is a protected resource.

9. A method of unifying a plurality of federations to enable federated access across the plurality of federations, the method comprising the steps of:
implementing a server that is communicatively coupled to each federation in the plurality of federations;
enabling access to the server as a centralized federated access portal to resources of service providers from users associated with each federation, the users being describable using one or more attributes; and
providing an interface from the server to the service providers to configure one or more acceptance rules that are used to filter the one or more attributes to determine whether access to the resources is granted to the users.

10. The method of claim 9 in which the server is arranged a) for providing an identity provider discovery process to the users, and b) for redirecting users to identity providers responsively to the process.

11. The method of claim 10 in which the identity providers perform identity verification of the users responsively to the redirecting and further publish the one or more attributes.

12. The method of claim 9 in which the attributes are defined at least in part through exclusion of personally identifiable information.

13. The method of claim 9 in which the interface is arranged as a front-end interface to a rules engine disposed in the server for implementing the federated access.

14. The method of claim 9 in which the interface is web-enabled through a plurality of point and click controls.

15. A computer-readable storage medium containing instructions which, when executed by one or more processors disposed in an electronic device, performs a method for facilitating identity provider discovery, the method comprising the steps of:
presenting a representation of a plurality of jurisdictions on a GUI, each of the jurisdictions having one or more federations by which federated identity management is implementable;
accepting input to the GUI for selecting a jurisdiction from the representation; and
displaying one or more user-selectable identity providers on the GUI responsively to the input, the one or more user-selectable identity providers being associated with the selected jurisdiction.

16. The computer-readable storage medium of claim 15 further including a step of accepting a user selection responsively to the displaying, the user selection indicative of an identity provider to which the user is associated.

17. The computer-readable storage medium of claim 16 further including a step of redirecting the user to the selected identity provider for verification of the user's identity.

18. The computer-readable storage medium of claim 17 in which the verification is used for single sign-on for access to one or more service providers.

19. The computer-readable storage medium of claim 15 in which the jurisdictions comprise countries.

20. The computer-readable storage medium of claim 15 in which the representation is selected from one of interactive map, text-based representation, or menu.
